(19) United States
(12) Patent Application Publication
(10) Pub. No.: US 2004/0194086 A1
(43) Pub. Date: Sep. 30, 2004

(54) Suspend and resume method of computer job

(75) Inventor: Kuniyasu Suzaki, Tsukuba-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: National Inst. of Advanced Ind. Science and Tech., Tokyo (JP)

(21) Appl. No.: 10/101,100

(22) Filed: Mar. 20, 2002

(51) Int. Cl. G06F 17/00; G06F 9/46

(52) U.S. Cl. 718/100

(57) ABSTRACT

This invention provides a method of suspending and resuming software execution that enables a software execution state to be saved and, as required, transferred to another computer and execution resumed. This is done by including a step of running a second computer program in a real or virtual computer system that emulates functions of a real or virtual computer configured using a first computer program that can save a snapshot of a computer system operation state at a specified time; a step of saving a snapshot of the virtual computer system, or a transmission step; a step of loading the saved or transmitted snapshot on a computer system that substantially corresponds to the real or virtual computer system; and a step of starting operations on a computer system that substantially corresponds to the real or virtual computer system.

### BACKGROUND OF THE INVENTION

1. Field of the Invention

The present invention relates to a method of suspending and resuming software execution that enables a software execution state to be saved and, as required, transferred to another computer, the software execution state reproduced and execution resumed.

2. Description of the Prior Art

Portable personal computers employ a hibernation function whereby the operations of a computer system on which software is being executed are suspended and, after some time has passed, the software is resumed. In order to suppress consumption of electric power while the portable personal computer is not being used, this function saves the contents of memory relating to the OS (operating system) and software to hard disk.

Also, technologies are already known that suspend execution of individual applications using databases and transfer operating information thereof to another computer. However, applications that can apply this have been limited by the fact that the applications have to be transfer-capable.

Fault-tolerant technologies include one in which the OS or application is equipped with application suspend and transfer functions. However, to enable the execution state to be accepted, the transfer destination has to be provided with an execution environment such as an OS and libraries for it.

When a conventional software execution suspend and resume method is used, such as the above-described hibernation function, even when the hibernation function is utilized, the operation information cannot be transferred because the power supply is switched off immediately after the memory contents have been saved. Also, since the BIOS has to have information to the effect that the hibernation function has been used, even if the memory contents saved to the hard disk are transferred to another computer, the application program cannot be resumed. Because, also, the transfer source and transfer destination computer systems have to have the same hardware configuration and OS, application to a variety of computer systems is not possible. A virtual computer can also have the ability to save a run state and to transfer and resume the state. However, this method requires that the transfer source and transfer destination virtual computers always be the same.

The present invention was proposed in view of the above situation, and has as its object to provide a method of suspending and resuming software execution that enables software operating on a real computer or virtual computer to save its own execution state and, when required, transfer it to a real computer or a virtual computer having the same configuration, and reproduce and resume the software execution state.

In the following description, a computer is hardware equipped with at least a processor (for example, a microprocessor unit: MPU), a first storage (for example, a hard disk: HDD) and a second memory that is faster than the first storage (for example, semiconductor memory: RAM), and a computer system is a computer that operates an OS on that hardware. Also, a virtual computer denotes a hardware function emulator running on the above computer system, and a virtual computer system refers to a computer running a predetermined OS on the hardware function emulator.

Also, “a program is operating” denotes a case in which this is under the control of an OS task manager or task scheduler, and “a plurality of programs is operating” simultaneously denotes a case in which these are simultaneously under the control of the same task manager or same task scheduler.

### SUMMARY OF THE INVENTION

To attain the above object, a first principal point of the present invention comprises resuming operation on a first real computer of execution contents saved on a first virtual computer system, characterized by including a step of running a second computer program in a virtual computer system that emulates functions of a first real computer configured using a first computer program that can save a snapshot of a computer system operation state at a specified time, a step of recording the virtual computer system snapshot on a readable storage medium, a step of reading out the snapshot recorded on the storage medium and loading it on a second real computer system having functions that substantially correspond to those of the real computer system, and a step of starting operations on the second real computer system.

A second principal point of the present invention comprises resuming on a virtual computer system a snapshot saved on a virtual computer system, characterized by including a step of running a second computer program in a virtual computer system that emulates a virtual computer system configured using a first computer program that can save a snapshot of a computer system operation state at a specified time, a step of recording the virtual computer system snapshot on a readable storage medium, a step of reading out the snapshot recorded on the storage medium and loading it on a second virtual computer system having functions that substantially correspond to those of the virtual computer system, and a step of starting operations in a computer system that substantially corresponds to the virtual computer system.

A third principal point of the present invention comprises transmitting and resuming operation of execution contents saved on a real or virtual computer system on an identical or different real or virtual computer system, characterized by including a step of running a second computer program in a virtual computer system that emulates functions of a real or virtual computer system configured using a first computer program that can save a snapshot of a computer system operation state at a specified time, a step of transmitting the virtual computer system snapshot, a step of loading the transmitted snapshot on a computer system that substantially corresponds to the real or virtual computer system, and a step of starting operations in a second virtual computer system hang functions that substantially correspond to the real or virtual computer system.

Further features of the invention, its nature and various advantages will be made apparent from the accompanying drawings and following detailed description of the invention.

### BRIEF DESCRIPTION OF THE DRAWINGS

FIG. 1 This is a schematic diagram of a configuration comprising two computer systems positioned apart, showing when processing being executed on one computer system by an application program is suspended and transferred to the other computer system where the processing continues.

FIG. 2 This is a schematic diagram showing a computer system in which Linux is used as the host OS, the well-known virtual computer simulation software VMware 2.0.3 is used as virtual hardware, and Linux on VMware is used as the guest OS.

FIG. 3 This is a schematic diagram showing a hard-disk partition configuration.

FIG. 4 This is a flow chart showing the operation of check-point software that takes a snapshot without halting OS execution.

### DESCRIPTION OF THE PREFERRED EMBODIMENT

[Outline]

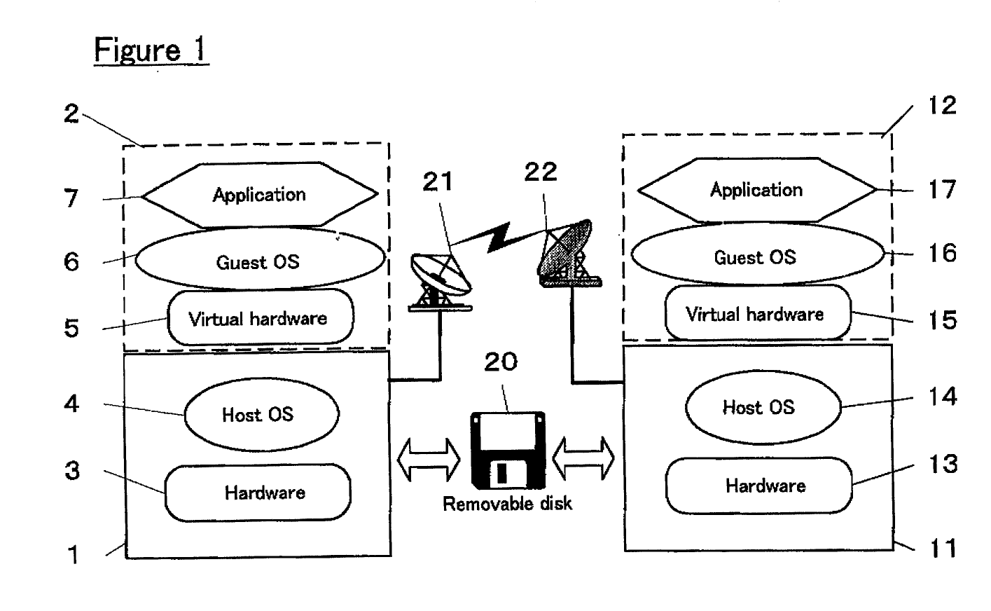

As a simple example, a case of two computer systems 1 and 11, positioned apart on which virtual computer systems 2 and 12, respectively, are running, as shown in FIG. 1, will be considered. To start, a brief description will be given of a case in which processing by an application program running on virtual computer system 2 is suspended, transferred to computer system 11 and the processing continued by virtual computer system 12.

Two computer systems 1 and 11 are shown in FIG. 1. Computer system 1 is, for example, hardware 3 that is a desktop PC on which host OS 4 is loaded. Virtual hardware (virtual computers) 5 is configured on the host OS 4, guest OS 6 runs on the virtual hardware 5, and an application 7 on the guest OS 6 carries out logical operations. The other computer system 11 is, for example, hardware 13 that is a notebook PC on which host OS 14 is loaded. Virtual hardware (virtual computer) 15 is configured on this host OS 14, and guest OS 16 runs on the virtual hardware 15. These two computer systems form a configuration in which data is transmitted by means of, for example, a communication path that uses satellite antennas 21, 22. Or, it can be a configuration in which data can be transferred by means of removable disk 20.

As shown in FIG. 1, during execution of application 7 controlled by the guest OS 6 being run by the virtual hardware (virtual computer) 5, an already well-known BIOS-independent hibernation is executed. In the course of this, the memory contents and device settings (snapshot) are saved to the hard disk and the guest OS stops. Next, the host OS 4 transfers a virtual hard disk (that to the host OS is one file) that includes a snapshot of the guest OS.

On the receiving side this is received by the host OS 14 and the virtual hard disk that includes the snapshot is used to start a virtual computer system. Then, when the snapshot is found during the guest OS 16 boot sequence, the contents thereof are expanded in memory, device settings returned and processing is resumed by the guest OS 16 on the receiving side, and the application 17 controlled thereby.

By doing this, looked at from the viewpoint of the application program executed by the guest OS, hardware changes have no effect.

Next, details of modes of the embodiment of the invention will be described. As one preferred example, a method of suspending an execution state in Linux will be described, starting with a description of an assumed hardware configuration.

[Hardware Configuration]

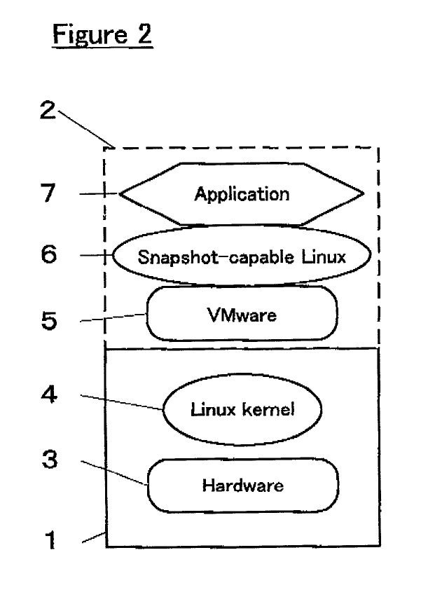

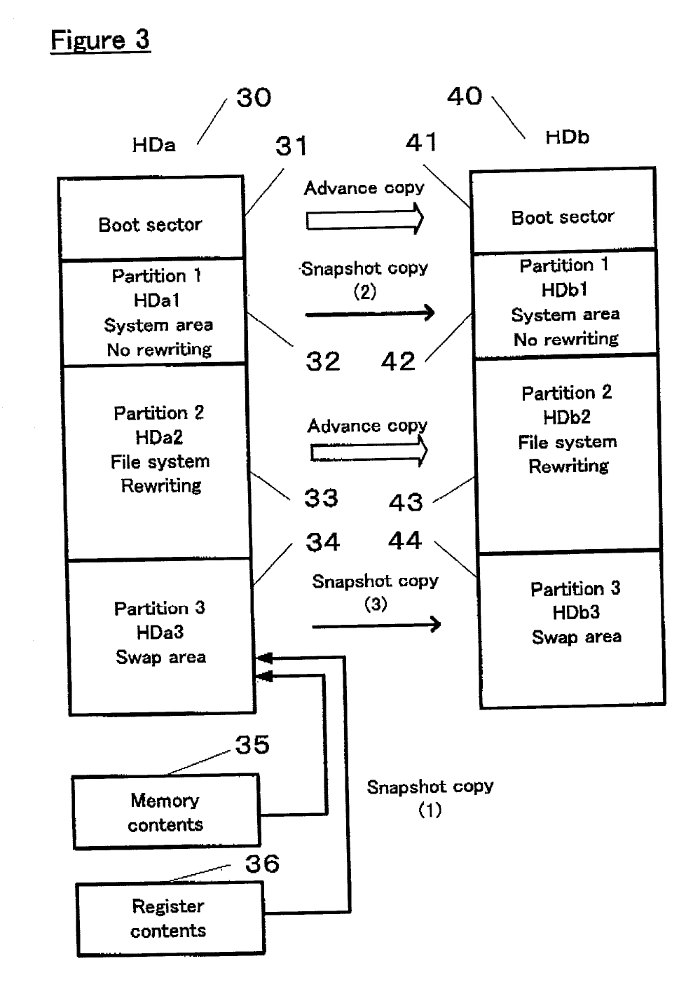

The system shown in FIG. 2 shows a computer system in which Linux is used as the host OS, the well-known virtual computer simulation software VMware 2.0.3 is used as virtual hardware 5, and Linux running on VMware is used as the guest OS 6. This system also runs a snapshot-compatible Linux OS as the target OS on the VMware, with two virtual hard disks being set as the IDE hard-disk emulation at that time, comprising a master (HDa) and a slave (HDb) connected to a primary controller. FIG. 3 is a schematic diagram showing the hard-disk partition configuration. By means of this configuration, a file retaining the system state can be utilized in the same way on almost all the computers, and it is also possible to start from exactly the same state on a plurality of computers.

[System Operation]

Next, FIG. 3 is used to explain the operation of this system.

In this system, HDa1 is utilized as the root file system and HDa2 as the /var file system. The root file system is mounted with a read-only attribute, and HDa1 is utilized as a swap area.

HDb uses exactly the same partition configuration as HDa. That is, exactly the same number of partitions and partition sizes are used. The root file system and boot sector are copied as images to the corresponding partition beforehand.

In this state, snapshot-compatible Linux OS is operated, using HDa1, HDa2 and HDa3. The snapshot function performs the following operations when directed to take a snapshot.

1) Processes and data in memory are output to the swap.

2) The swap partition and /var partition are each copied to the corresponding partition in HDb.

3) Memory that was used for working and the swap are released, and the system resumes from the state prior to the snapshot.

Thus, the system state is retained in HDb. Since the root file system is mounted as read-only, during operation of the Linux OS, utilizing the fact that the contents do not change, a copy is not made at the snapshot point. This is for speeding up snapshots.

Under the VMware environment, virtual hard disks HDa and HDb exist as single files within the host OS, enabling the file corresponding to HDb to be utilized as the snapshot system state. Also, with respect to copying read-only partitions (in the above example, only the root file system in HDa1) and boot sectors prior to system startup, this can be readily done by copying the one corresponding file on the hard disk under the host OS.

[System for Taking Snapshots]

First, checkpoint software used to take a snapshot without stopping OS execution will be outlined. The software used was SWSUSP (SoftWare SUSPend) with the following enhancements.

(1) A new hard-disk copy is prepared. The contents of the existing hard disk are copied to this hard disk.

(2) A /etc/checkpoint.conf file is prepared and the snapshot disk partition designated.

(3) The shutdown command, Linux kernel source code are enhanced as follows. The shutdown command flags were increased to one flag (−x) more than SWSUSP. In accordance with the −x flag, the OS reads the content of /etc/checkpoint.conf and, via a reboot system call, passes the content and a new command to the kernel.

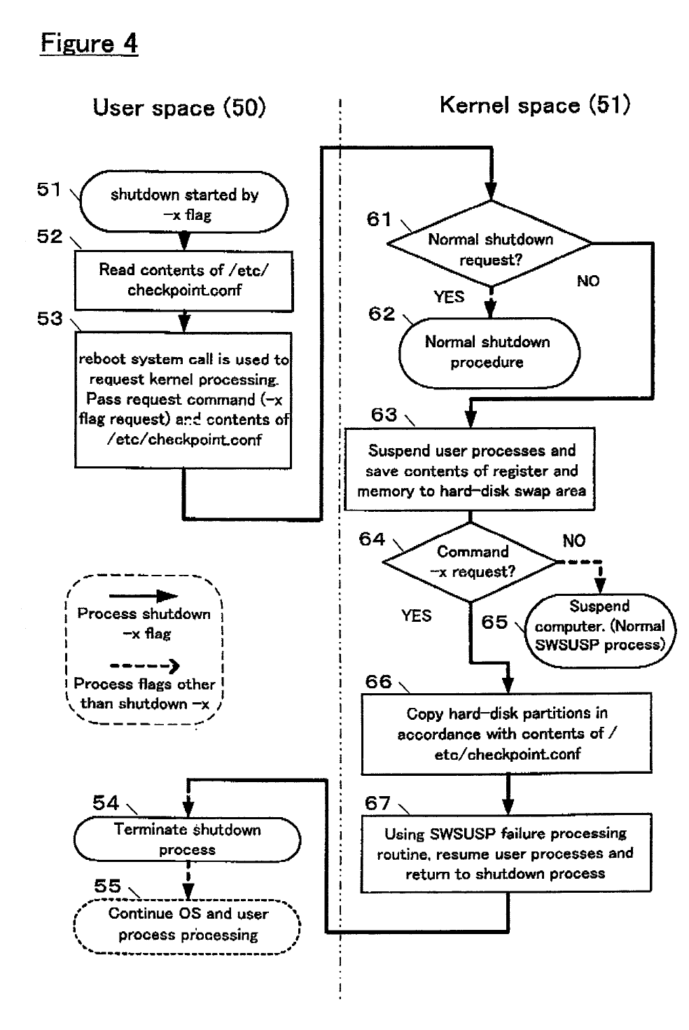

The sequence of this process is shown in the flow chart of FIG. 4.

A system for taking a snapshot comprises

a) a Linux kernel, and

b) a utility (shutdown command). The utility triggers a snapshot operation request to the Linux kernel. The actual snapshot operation is achieved by means of the Linux kernel.

The snapshot operation will be explained using the flow chart of FIG. 4.

1) Step 51: The operation is started by a shutdown command.

2) Step 52: The shutdown command reads /etc/checkpoint.conf.

3) Step 53: The shutdown command issues a reboot system call.

5) Step 63: The Linux kernel initiates suspension.

6) User processes are suspended and contents of registers and real memory are saved to an empty swap area.

7) Step 66: The necessary partitions including swap partitions (designated by checkpoint.conf) are copied.

8) Step 54: Resume or power-off is performed depending on the operating mode.

Also, the shutdown command is based on a Software Suspend patch at sysvinit-2.76; when the shutdown command is started by a flag requesting a suspend or checkpoint operation, the next operations are performed.

1) /etc/checkpoint.conf is read.

2) A reboot system call is issued.

The reboot system call argument is, for example, as follows.

reboot(magic1, magic2, cmd, arg);

magic1: magic number for example Oxfee1deadmagic2: magic number for example 672274793

cmd: command

0xD000FCE2: Do suspend operation (1).

0x19940107: Do checkpoint operation.

0x19950906: Do suspend operation (2).

Other commands are the same as those of the original Linux. arg: command argument

With the snapshot function, is used to designate the partitions that are copied.

Designate the following struct checkpoint_copy_list address.

Suspend operations (1) and (2) shown above correspond to the normal shutdown procedure shown in step 62 of FIG. 4. The suspend operation (1) disconnects the power supply without performing the copying designated by arg, leaving information for the resuming in the swap. The suspend operation (2) performs the copying designated by arg and disconnects the power supply without leaving information for the resuming in the swap.

struct checkpoint_copy_list {int count;struct checkpoint_copy_pair list[0];};

count: Designation of array length designated in list.

list: array of paired copy source and copy destination.

struct checkpoint_copy_pair{char from[CP_PATH_LENGTH];char to[CP_PATH_LENGTH];};

from: Designation of copy source device file.

to: Designation of copy destination file.

Step 64 and subsequent steps are processed as follows. The shutdown command reads /etc/checkpoint.conf, produces a checkpoint_copy_list and issues a reboot system call. In the case of this example, Table 1 shows the relationship between this shutdown flag and the reboot system call command.

TABLE 1

| Flag | Command |
|---|---|
| −x | Checkpoint operation |
| −z | Suspend operation (1) |

When a snapshot operation is requested by a reboot system call in step 66, the Linux kernel performs the following operations.

1) Designated operating mode information and partition information of the partition to be copied is saved in internal variables.

2) The snapshot operation enters a queue in the kernel and waits for the snapshot operation to be enabled.

3) User processes are suspended and contents of registers and all memory are copied to a swap.

4) From step 67 onward, processing is performed in the following order, although the following operations differ depending on the operating mode.

a) Copying is done in the order according to the copy partition information. Routines that process the copy open read, write, close system calls are called directly and used. The corresponding function is save_disk_image ( ) of kernel/swsusp.c.

b) Swap areas used to copy contents of registers and all memory, are released. The corresponding function is cleanup_unused_swap_pages( ) of kernel/swsusp.c.

c) Buffers that were used for working are released. While this is not essential since they free up automatically even if they are left as they are, they are released here because there is little likelihood that used buffers will be re-utilized. The corresponding function is free_unuse_buffer( ) of kernel/swsusp.c.

d) The power supply is disconnected. If the power supply is not turned off, a return to normal operation is possible by using the same routines used to recover from a suspend failure. Whether these processes are implemented or not depends on the operating mode Table 2 shows which processes are implemented in the following operating modes.

TABLE 2

| Mode | a) | b) | c) | d) |
|---|---|---|---|---|
| Checkpoint | Yes | Yes | Yes | Recover |
| Suspend (1) | No | No | No | End |
| Suspend (2) | Yes | Yes | No | End |

[Resuming Processing from Transferred or Saved Snapshot]

In cases in which it is desired to resume from the snapshot taken by the breakpoint software, the current OS is terminated and started after changing hard disks. If this hard-disk changeover is done with a virtual computer, it can be done by just changing file names instead of by physical movement.

The following describes the procedure of resuming processing from the binary data of a snapshot that is transferred or saved.

1) The virtual disk that was being used as hdb in the VMware linux.cfg on computer system 1 (transfer source) is used as hda in linux.cfg on computer system 11 (transfer destination). Specifically, assuming that linux.cfg on the computer system 1 has the following description:

ide0:0.fileName=“./hda.dsk”

ide0:1.fileName=“./hdb.dsk”,

the hdb.dsk file is transferred to computer system 11 and on the computer system 11 linux.cfg is given the following:

ide0:0.fileName=“./hdb.dsk”.

2) Next, modified linux.cfg file is used to start VMware.

3) Next, a Power On operation is carried out on VMware.

4) In accordance with this operation, Linux starts, the system returns to the state at which the snapshot was taken, and processing can resume.

The above description refers to an example in which, on the computer system on the transfer side, Linux is used as the host OS and Linux on VMware is used as the guest OS, and on the computer system on the side that receives the transfer, similarly, Linux is used as the host OS and Linux on VMware is used as the guest OS. However, a slight change makes it easy to resume processing using Linux as the OS on the computer system on the transfer-receiving side.

In other OSs or other virtual computers, too, substantially the same procedure as that described in the foregoing can be used to readily suspend execution of active application software and execution of the application software resumed on another computer system by transmitting the suspended state over a communication path or by transporting the state saved on a removable disk.

The present invention configured as described in the foregoing can be applied in the following ways.

(1) Transfer

Since it is possible to transfer a snapshot of an OS that is running, a task that was being carried out in the workplace can, for example, be continued at home.

Moreover, it enables the exchange of debugging states during joint development of application software, making it possible to increase development efficiency. With current debugging, joint developers are informed by mail of the sequence of conditions under which a bug is generated in software. The joint developers use the sequence to reproduce the bug, after which the bug is removed from the software. Being able to exchange OS snapshots would eliminate the task of making detailed descriptions of bugs and reproducing them, and being out of synch with communications, thereby enabling efficient development.

(2) Rollback

Being able to take a snapshot of an OS that is running means that, even when processing has proceeded on from that state, it is possible to perform a rollback to the point at which the snapshot was taken. This feature can be used to perform rollbacks to OS or application run states as well as to perform data rollbacks. With this function, even if an application fails in the middle of a long period of processing, processing does not need to be restarted from the beginning but can instead be started from part way through.

(3) Distribution

Being able to take a snapshot of an OS that is running enables the state thereof to be copied and distributed to other computers. Enabling distribution of copies of applications that are running makes it easy to distribute trial evaluation versions. The party that creates the application does not have to create an installer for the evaluation version, simplifying the creation of the evaluation version.

(4) Less Work to Install and the Life of Software is Extended

Being able to transfer snapshots of an OS that is running means that once a user has installed an application in a transferable OS, that environment can be utilized even on another computer, making it possible to cut down on installation operations.

Also, the software environment can continue to be used without having to reinstall applications each time a replacement computer is purchased. This function makes it possible to extend the life of software and enables software to survive that cannot handle frequent hardware releases and OS upgrades.

(5) Transfers Between Real Computer and Virtual Computer

OS snapshots can be transferred between a real computer and a virtual computer by giving both computers the same configuration. In this case, on the real computer side an OS is required that accepts a transferrable OS. After a snapshot of the transferrable OS has been copied to a bootable portion of the hard disk, rebooting can start the transferrable OS.

The ability to make transfers between an real computer and a virtual computer enables applications requiring efficiency to be carried out on real computers.

What is claimed is:

1. A method of suspending and resuming software execution, characterized by including: a step of running a second computer program in a virtual computer system that emulates functions of a first real computer configured using a first computer program and can save a snapshot of a computer system operation state at a specified time; a step of recording the virtual computer system snapshot on a readable storage medium; a step of reading out the snapshot recorded on the storage medium and loading it on a second real computer system having functions that substantially correspond to those of the real computer system; and a step of starting operations on the second real computer system.

2. A method of suspending and resuming software execution comprising resuming on a virtual computer system a snapshot saved on a virtual computer system, characterized by including: a step of running a second computer program in a virtual computer system that emulates a virtual computer system configured using a first computer program that can save a snapshot of a computer system operation state at a specified time; a step of recording the virtual computer system snapshot on a readable storage medium; a step of reading out the snapshot recorded on the storage medium and loading it on a second virtual computer system having functions that substantially correspond to those of the virtual computer system; and a step of starting operations in a computer system that substantially corresponds to the virtual computer system.

3. A method of suspending and resuming software execution characterized by including: a step of running a second computer program in a virtual computer system that emulates functions of a real or virtual computer system configured using a first computer program that can save a snapshot of a computer system operation state at a specified time; a step of transmitting the virtual computer system snapshot; a step of loading the transmitted snapshot on a computer system that substantially corresponds to the real or virtual computer system; and a step of starting operations in a second virtual computer system having functions that substantially correspond to the real or virtual computer system.
